(19) United States
(12) Patent Application Publication
(10) Pub. No.: US 2001/0027384 A1
(43) Pub. Date: Oct. 4, 2001

(54) Wireless internet bio-telemetry monitoring system and method

(76) Inventors: Arthur E. Schulze, Wharton, TX (US); Tommy G. Cooper, Friendswood, TX (US); Emil S. Macha, Sugar Land, TX (US)

Correspondence Address: Roberts Abokhair & Mardula, LLC, Suite 1000, 11800 Sunrise Drive, Reston, VA, 20191-5302, US

(21) Appl. No.: 09/783,913

(22) Filed: Feb. 15, 2001

Related U.S. Application Data
(63) Continuation-in-part of application No. 09/516,645, filed on Mar. 1, 2000.

(51) Int. Cl. G06F 11/00; G06F 15/00

(52) U.S. Cl. 702/188

(57) ABSTRACT

The patient worn monitoring device wirelessly monitors patient variables and connects to a variety of sensors with at least one microphone and speaker for voice communications. The patient-worn device connects to a wireless network and thence to the Internet for transmitting data to a Host for access by a health care provider. The health care provider communicates with the patient worn device via the Host over the Internet and the wireless network to send instructions to the patient-worn monitoring unit and to communicate over the wireless network via voice with the patient. The health care provider can also flexibly reconfigure the patent-worn monitoring device to change data collection parameters for the sensors worn by the patient. When an alarm limit is exceeded and detected by the sensors, it is transmitted over the wireless network and thence over the Internet to the Host computer for use by the health care provider.

### RELATED APPLICATIONS

This application is a continuation-in-part of U.S. application Ser. No. 09/516,645, filed Mar. 1, 2000, now pending.

### FIELD OF THE INVENTION

This invention relates generally to medical monitoring devices. More particularly the present invention is a system and method for monitoring physiologic variables of an individual in a wireless manner over the Internet.

### BACKGROUND OF THE INVENTION

Monitoring devices of various types to monitor patient physiologic conditions have long been in the medical community. A plethora of testing and monitoring equipment have moved out of the hospital into the doctors' offices and, in some cases, have even progressed into home monitoring systems.

While these devices have clearly been extremely useful, many of these devices require that a patient be located at home, or in close proximity to a telephone system, such that results of the monitoring can be transmitted over the public switched telephone network (PSTN) to some form of analysis center. Such devices do not necessarily lend themselves to the mobile life style in which many individuals find themselves.

For example, it is difficult for a busy person to stop in the middle of the day, proceed to a monitoring station (whether it be at home or in some office) take the appropriate measurements, and then proceed with the business of the day. This simply is not possible and adds a level of stress to the already stressful situation of having to monitor physiologic signals.

What would truly be useful is a system for monitoring physiologic characteristics of an individual on a mobile basis. Such a system would require little if any interaction with a monitoring device. Signals that are collected would then be sent in an automated fashion to an analysis center or a physician's office. Alternatively, a physician could interrogate the system worn by a patient while the patient is mobile to obtain the physiologic signals of interest.

### SUMMARY OF THE INVENTION

It is therefore an objective of the present invention to monitor remotely the physiologic variables from any patient.

It is a further objective of the present invention to monitor physiologic variables of a patient (regardless of whether the patient is ambulatory or stationary) when the physician is remote from the patient.

It is yet another objective of the present invention to monitor physiologic variables using the Internet.

It is a further objective of the present invention to monitor physiologic variables in a wireless manner within a generalized geographic area.

It is a further objective of the present invention to monitor physiologic variables without the patient having to proceed to any centralized location in a geographic area.

It is a further objective of the present invention to monitor a patient anywhere in the coverage map of a cellular- or satellite-based telephone network.

It is a further objective of the present invention to have data relating to physiologic variables automatically sent over a wireless network to a physician or other medical caregiver using the Internet.

It is a further objective of the present invention to allow a physician to interrogate the physiologic monitoring device in a wireless fashion whenever the physician needs to take such physiologic measurements.

It is a further objective of the present invention to provide voice communications in a wireless mode to and from a medical caregiver.

It is a further objective of the present invention to have a “panic” function which allows both a user to send a panic message to a physician or allows a physician, after monitoring physiologic signals, to send a voice “advice” message to the patient.

It is a further objective of the present invention to accomplish all the above objectives using a device that is worn by the patient in a relatively unobtrusive fashion.

These and other objectives of the present invention will become apparent to those skilled in the art from a review of the specification that follows. The words physician, doctor, healthcare provider, caregiver, medical care provider, care provider, etc. as used herein shall mean the person with responsibility for the care of the patient.

The present invention is a wireless Internet bio-telemetry monitoring system (WIBMS). The system makes use of a variety of bio-sensors which are generally used to detect signals or variables from the human body. One such sensor system is described in U.S. Pat. No. 5,673,692 whose characteristics are incorporated herein by reference in their entirety. However, this particular sensor is not meant as a limitation. Literally any type of bio-sensor or physical sensor generally known to those skilled in the art will find use in the present invention. Further, the sensor of U.S. Pat. No. 5,673,692 can be modified to include a microphone so that voice of the patient can be transmitted using the system of the present invention.

The sensors are connected to a combination data acquisition module and wireless transceiver which is worn by the patient. This combination sensor package and communication unit is known as the Multi-Variable Patient Monitor, or MVPM. The MVPM is battery-powered. The batteries that power the MVPM can be single use batteries or rechargeable batteries. Further, when the individual is in a mobile state, the batteries of the MVPM can be recharged by plugging them into a car or into normal wall current. This allows the individual to constantly keep batteries charged in the MVPM whether the individual is mobile or in an office.

As noted above, the MVPM is a patient-worn device which allows maximum mobility to the particular patient.

The MVPM has the ability, on a periodic basis, to interrogate bio-sensors worn by the patient and to store physiologic signals from the bio-sensors. On a periodic basic, the MVPM calls into a wireless network and transmits the bio-sensor information to the wireless network. The bio-sensor information then proceeds from the wireless network to the Internet and then to an analysis center or a data warehouse which receives and stores the information for subsequent analysis.

The MVPM also comprises emergency Panic buttons whereby a patient can direct the transceiver portion of the MVPM automatically to call 911 or a designated medical caregiver in the event of a medical emergency.

As noted above, the MVPM is connected to various sensors. Therefore, the MVPM has sensor condition detection circuitry, connected to a lamp and/or message display, which allows a user to determine that all sensors are operating correctly. When a sensor receives a particular signal which is out of the normal physiologic range for the particular patient, an “alarm” (sound, lamp, or display) is actuated such that the patient can understand that a significant medical event is occurring. Simultaneously with such an alarm, a time-tagged signal is sent to the medical care provider terminal notifying the caregiver of the event.

Thus, when the MVPM is functioning in a data acquisition mode, it receives information from the sensors, performs some limited analysis on that information, and notifies the patient and caregiver of any non-standard conditions.

When the MVPM periodically sends stored signals from the sensors over the network, a unique identifier is encoded with any such data that are sent such that the data can be directly associated with a particular patient.

Once data are received at the Host server, the data are stored with appropriate privacy and security issues dealt with in a manner known to those skilled in the art.

The MVPM also comprises circuitry for self-testing its various sub-systems and sensors and for communicating any trouble shooting information directly to the patient in the event that the sensor becomes dysfunctional. Further, such trouble-shooting data can also be sent in a wireless manner to the central server such that trouble-shooting can take place remotely, or in the alternative, a new MVPM unit can be sent to the patient.

The MVPM also can be preset before giving it to a patient. In addition, and depending upon the biological signals being monitored, “Alarm” variables can be set remotely by the health care provider over the Internet and subsequently via the wireless network and can be based upon the caregiver's knowledge of the condition of the patient. Such remote setting also occurs via the two-way communication of the transceiver portion of the MVPM.

Communication rates of the WIBMS are optimized to fit wireless telephone communications calling and rate plans and to minimize the cost and air time usage.

Using the WIBMS, the following types of monitoring can take place:

digitally sampled electrocardiogram

patient body temperature

pulse oximetry

pulse rate

other physiologic variables, such as blood glucose, respiration, etc.

various pre set alarm conditions or physiologic variables

event occurrences per patient action/input.

As also noted above, the MVPM has bi-directional communication capability and has the capability to transmit a “panic” signal over wireless network, to initiate 911 calls, to allow patient-initiated voice-calling over a cellular telephone link, and to allow medical provider voice-calling to the patient over a cellular telephone link.

Other characteristics of the present invention will become apparent to those skilled in the art by review of the detailed description of the invention that follows.

### BRIEF DESCRIPTION OF THE FIGURES

FIG. 1 illustrates the Wireless Internet Bio-telemetry System.

FIG. 2 illustrates the Multi-Variable Patient Monitoring portion of the WIBMS.

FIG. 3 illustrates a front panel drawing of the multi-variable patient monitor portion of the WIBMS.

### DETAILED DESCRIPTION OF THE INVENTION

As noted above, the present invention is a Wireless Internet Bio-telemetry System comprising a patient monitoring device which is conveniently worn by a patient and which comprises sensors together with a combination network that allows biologic and physical signals to be reviewed and acted upon by a health care provider who is located remotely from the patient. Data from the monitoring system are then sent in a wireless mode over a cellular network to the Internet and then to a data analysis center (Host) for retrieval and review by a medical care provider.

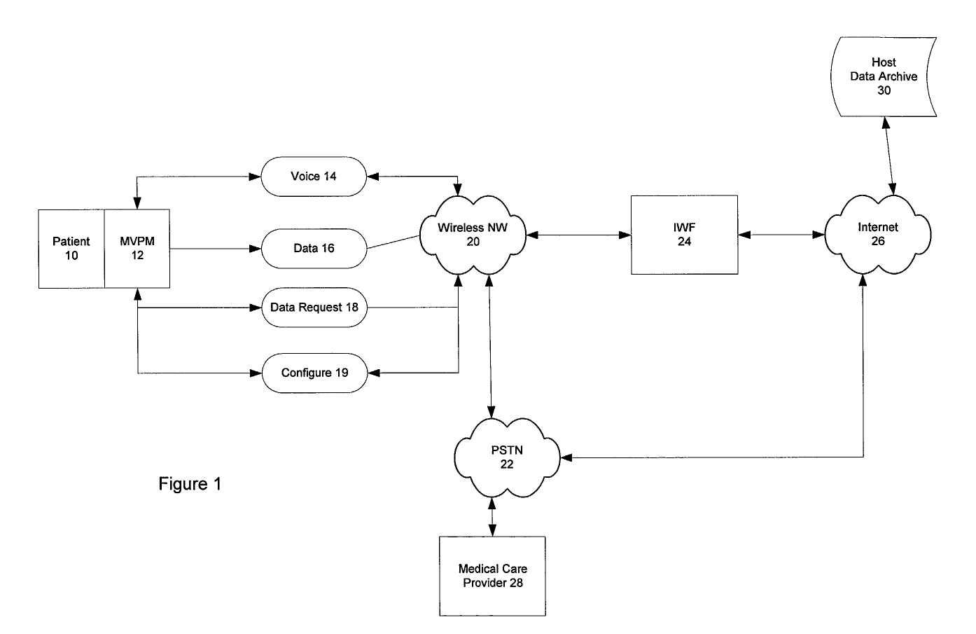

In FIG. 1, the Wireless Internet Bio-telemetry System (WIBMS) is illustrated. Patient 10 wears a Multi-Variable Patient Monitor (MVPM) 12. This MVPM monitors a variety of bio-signals as further noted below. The MVPM 12 has the capability of communicating bi-directionally via voice 14 in much the same manner as a normal cellular telephone. However, in addition, the MVPM sends data 16 on a periodic basis, or in some cases on a continuous, Real-time basis, over a cellular network to the Internet and then to the Host. It also receives requests for data 18 which may be made by a medical care provider over the Internet using wireless or PSTN connections to the Host.

Wireless Network 20 is the normal digital cellular telephone network currently in use. This type of network is not however meant as a limitation. For example, PCS networks and other types of wireless loop networks are also suitable for transmission of the voice and data envisioned by the present invention. It will be apparent to those skilled in the art that such other networks can satisfy the requirements for transmission of voice 14, data 16, and request for data 18 to and from patient 10.

Once physiologic data is transmitted over network 20, it is then transmitted via an Interworking Function (IWF)® 24 (for example), preferably to the Internet 26 for subsequent retrieval and review by a medical care provider at the medical care provider terminal 28. In addition, data can be archived (again via the Internet 26) to a data archiving and distribution facility 30 (“Host”). Data that are archived are stored in a private and secure fashion using techniques known in the art that allow secure transmission and access limitations.

In the event that voice traffic is being transmitted from the patient, a cellular network 20 connects to the public telephone network 22 to communicate with the medical care provider (or 911 operator). Although network 22 will usually be a PSTN, other non-switched connections, such as ISDN, DSL, satellite, and cable modem connections can also be used. Again, in this fashion, the medical care provider can receive voice information from the patient 10 and provide voice feedback to the patient as well. Similarly, the medical care provider terminal 28 can both receive traffic from the WIBMS as well as transmit requests for data and configuration changes to the Host 30. In turn, the Host 30 communicates these requests to the MVPM 12, receives data, and provides it back to the caregiver over the Internet 26 and PSTN 22. All data that are received from the MVPM (and the network) can be archived by the Host 30 so that the data from the specific patient can be monitored over time and so that data can be analyzed for trends that can be used for alarm setting and data collection protocols. All such data are transmitted in an encrypted and possibly non-attributable form with limited access using methods known in the art so that patient privacy and confidentiality is maintained.

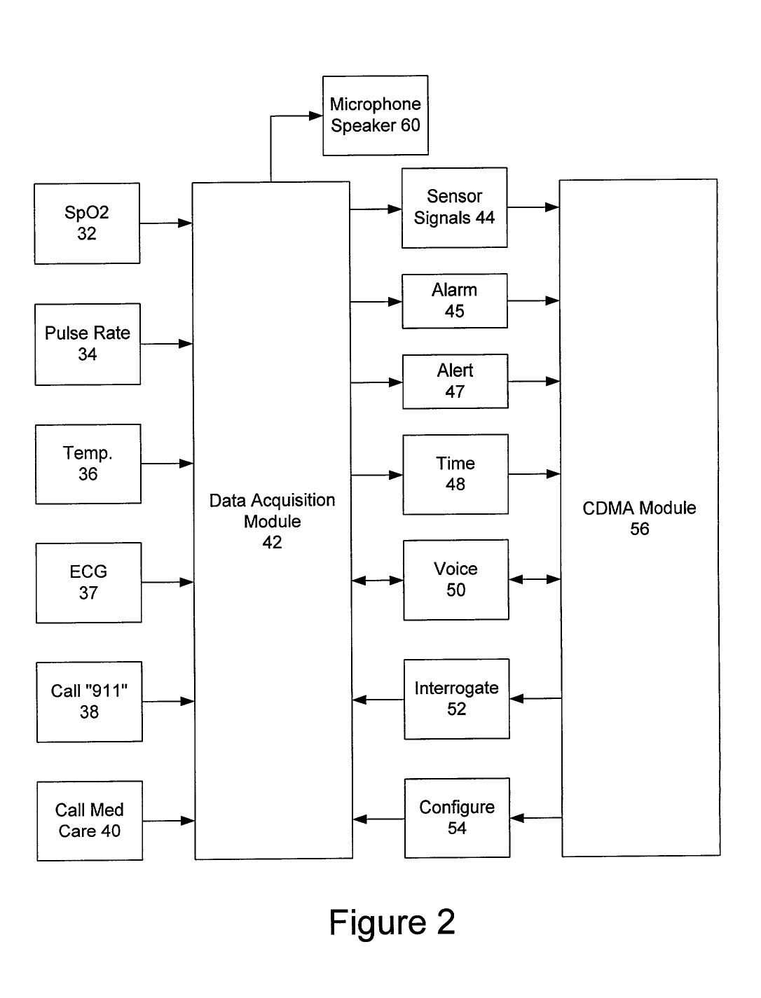

In FIG. 2, the Multi-Variable Patient Monitor (MVPM ) is further illustrated. The MVPM (initially noted as 12 in FIG. 1) comprises, without limitation a number of sensors. For example, blood oxygen saturation level (Sp02) 32, pulse rate 34, body temperature 36, and Electrocardiogram (ECG) 37 can all be measured by sensors associated with the appropriate measurement. Signals from the sensors are picked up and stored by the Data Acquisition Module 42. This information from the sensors 44 is then sent to the CDMA (although other module types may also be used) telephone module 56 of the MVPM for subsequent transmission.

In addition simply to acquiring data, the Data Acquisition Module 42 also notes any Alarm condition 46 and transmits that information via CDMA module 56 over the Internet 26 to the Host 30 where it can be used to notify a medical care provider terminal 28. Also, Data Acquisition Module 42 transmits the time of day 48 with any transmission of alarm information or sensor information. As noted earlier, the various alarm conditions can be reconfigured by the health care provider over the internet and the wireless network without any patient interaction.

The CDMA module is, for example, one manufactured by Qualcomm® for use within a cellular telephone. That information, in connection with 3Com QuickConnect® Internet connection software and 3Com Interworking Function® (IWF) device are all used to connect to, for example, the Sprint PCS® digital cellular telephone network. The characteristics of the Qualcomm® CDMA cellular phone module, the 3Com QuickConnect® Internet connection software and the 3Com IWF® device are all incorporated herein by reference in their entirety.

The CDMA module 56 allows for digital cellular communications at 14.4 kbps which is sufficient for the transmission of the bio-sensor information contemplated by the present invention. This is not however meant as a limitation, since faster wireless modulated speeds surely will become available. All of these faster connections will be suitable for transmission of the data and voice of the present invention.

Data that are collected are encrypted to prevent eavesdropping or tampering with any commands. All information and data are Internet Protocol (IP) compatible and contain error checking to insure data accuracy.

The Data Acquisition Module 42 continuously monitors, for example and without limitation, Sp02 32, pulse rate 34, body temperature 36, and ECG 37, and transmits that information from the MVPM to the Host over the Internet. Data can be transmitted in real time and/or can be stored and forwarded depending upon the collection protocol ordered by the medical service provider. Similarly, temperature measurement, pulse oximetry, and pulse rate all can be collected and transmitted continuously during various periods of time or can be collected stored and burst transmitted over the wireless network as required.

The Data Acquisition Module contains logic that allows an “Alarm” 45 condition to be transmitted at any time whenever the alarm criteria are fulfilled. Further, any alarm condition can be reset by the health care provider via the Host over the Internet and thence over the wireless network. Any “Alert” 47 signals that, for example, a sensor is turned off, broken, or has become disconnected is used to alert the patient to take appropriate action to replace or repair the sensor. While such information is transmitted by the Data Acquisition Module 42 to the CDMA module 56 and thence to the wireless network, a voice synthesizer contained in the Data Acquisition Module 42 also provides a voice alert via speaker 60 to the patient that a particular Alarm 45 or Alert 47 condition has occurred.

As noted earlier, the patient also has the ability to speed dial 911 38 as needed. Data Acquisition Module 42 also processes this information and passes it over a voice connection 50 to the CDMA module 56 and thereafter to the Wireless Network 20 for communication. The patient also has the ability to call the medical care provider on a non-emergency basis. This is accomplished by a dedicated function speed dial “button” 40 on the MVPM. Again, Data Acquisition Module 42 processes voice information 50 and passes that information to the CDMA module 56.

As noted above, the medical service provider or other organization that is responsible for monitoring and maintaining the MVPM can interrogate the Data Acquisition Module of the MVPM through the Host. A request for information flows from the medical care provider terminal over the Internet to the Host. The Host initiates a voice call to the MVPM which triggers the MVPM to establish a data call back to the host. Alternatively, the Data Acquisition Module can be reconfigured 54 to update communications capabilities, or to change the protocol for monitoring physiologic data and to change or modify alarm limits.

The system of the present invention includes the network and can allow any number of MVPMs. In the same fashion that a cellular telephone has a roaming capability, so does the MVPM, therefore allowing the continual transmitting and updating of physiologic data.

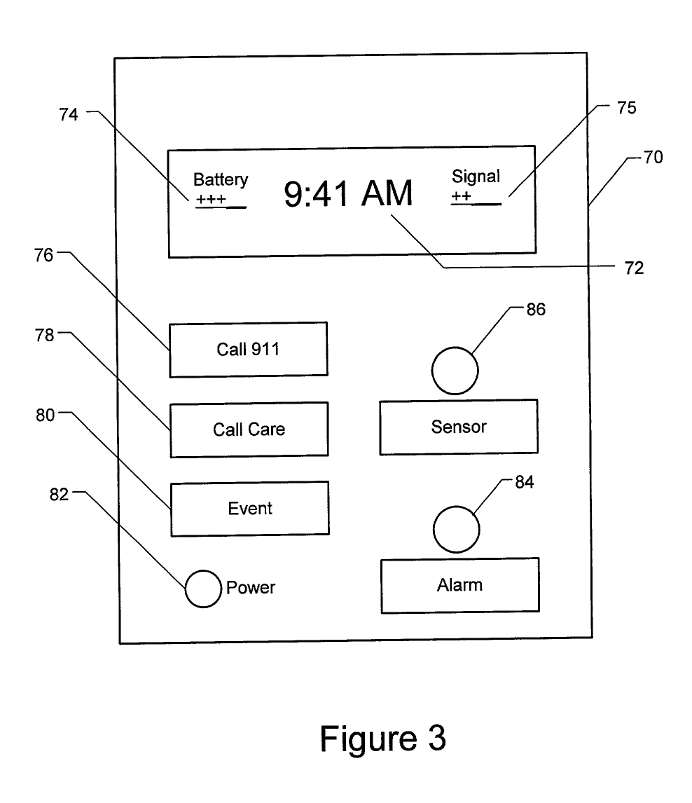

In FIG. 3, a front panel for the MVPM is illustrated. The MVPM has a time of day 72, battery capacity 74 and signal strength 75 indicators which allow the wearer to determine if recharging or battery replacement is required and if the signal strength of the communications channel is adequate to support reliable communications. The panel 70 is dimensioned to be small and unobtrusive so that the wearer will not be disproportionately burdened by carrying the MPVM. The panel has several speed dialing preset buttons that allow emergency calls to 911 76 to be made and to call the care provider 78 simply by pressing a button. Similarly, if the wearer determines that an “Event” has occurred such as faintness, shortness of breath, irregular heartbeat, or other symptoms, this event button 80 can be pressed causing data be stored and transmitted for a preset period of time. A power indicator 82, such as a flashing green LED, is part of the panel so that the user can determine that power is “On.” Sensor lamp 86, such as a yellow LED, is on the panel as well to inform the user when a sensor has potentially become disconnected or has otherwise malfunctioned. An Alarm lamp 84, such as a red LED, together with an audible signal is also present on the control panel so that the patient can have both a visual and audible warning of any Alarm condition that might exist.

The panel design shown in this FIG. 3 is by way of illustration only. It will be apparent to those skilled in the art that other panel designs are possible so long as the information is presented in an easy and usable way for the patient.

As noted above, the communications link between the MVPM and the care provider via the PSTN or the Internet is a bi-directional link. Thus, requests for data from a workstation located at the care provider's facility can be transmitted through the Internet to the Host which contacts the MVPM. Data transfer (real time or stored) can be transferred from the MVPM through the Internet to various data bases for analysis or storage. Data from the MVPM can be transferred in real time to or from the storage site through the Internet to other authorized users such as insurance providers. Alarm information is transferred from the MVPM to the care provider through the Internet. When a sensor malfunctions or becomes disconnected from the wearer, a “sensor off” signal is sent from the MVPM and transferred over the Internet to the medical care provider terminal so that such information is available and so that the caregiver can know when and if it is repaired. Event occurrences, as described earlier, may also be transferred to the Medical Care Provider through the Host. The medical care provider terminal can transmit a communication to disarm or reset alarms in the MVPM through the Internet as necessary. Further, protocols relating to when and the type of bio-signal to be measured can be sent from the medical provider over the Internet to the Host which transmits this information to the MVPM. The personal emergency button for use by the user to activate a call to the Medical Care Provider gives voice communication from the MVPM to and from the care provider. Real-time clock resets or any other variations in configuration of the MVPM can be transmitted from the Medical Care Provider over the Internet to the Host which transfers this information to the MVPM using the Internet and the Wireless Network.

A Wireless Internet Bio-telemetry System has now been illustrated. It is important to note that, while a particular wireless protocol was described in the preferred embodiment (i.e., CDMA) this is not meant as a limitation. For example, other protocols for communication in a digital wireless network (such as a GSM or a TDMA network) will be equally suitable for use with the present invention. It is also anticipated that other types of wireless networks will also be suitable such as satellite networks and wireless local loop networks. The requirement is that there be two-way communication with the MVPM and that Internet connectivity flow as part of the communication system to allow interaction between health care provider and the patient through voice and data links using the Internet. It will be apparent to those skilled in the art that other variations in, for example and without limitation, the type of network, the types of sensors, and the configuration of the patient monitor can be accomplished without departing from the scope of the invention as disclosed.

We claim:

1. A system for remotely monitoring patient variables, comprising:
at least one patient-worn sensor;
a patient-worn monitoring unit connected to the sensor;
said patient-worn monitoring unit comprising a processor and further comprising a wireless communication device connected to a first wireless network, wherein said first wireless network is adapted to send and receive communications over the Internet;
a Host data archive connected to the Internet to communicate with the patient-worn monitoring unit;
a second network connected to the Internet and first wireless network;
a terminal means connected to the second network for communication in a bi-directional manner between a medical care provider and the patient-worn monitoring unit over said second and first networks.

2. The system for remotely monitoring patient variables of claim 1, wherein the communication with the patient-worn monitoring unit is bi-directional data communication.

3. The system for remotely monitoring patient variables of claim 1 wherein the communication with the patient-worn monitoring unit is bi-directional voice communication.

4. The system for remotely monitoring patient variables of claim 2 wherein the bi-directional data communication further comprises instructions from the health care provider terminal to change configurable program instructions in the monitoring unit processor.

5. The system for remotely monitoring patient variables of claim 4 wherein the instructions to change configurable program instructions comprises instructions to change alarm limits.

6. The system for remotely monitoring patient variables of claim 4 wherein the instructions to change configurable program instructions comprises instructions to change data collection parameters for the at least one sensor.

7. The system for remotely monitoring patient variables of claim 3 wherein the bi-directional voice communications comprises voice communications with a health care provider professional.

8. The system for remotely monitoring patient variables of claim 7 wherein the sensor further comprises a microphone for allowing voice communications.

9. The system for remotely monitoring patient variables of claim 8 wherein bi-directional voice communications occurs via the microphone and a speaker contained in the patient-worn monitoring unit.

10. The system for remotely monitoring patient variables of claim 1 wherein the second network is a PSTN.

11. The system for remotely monitoring patient variables of claim 1 wherein the sensor is a bio-sensor.

12. A method for remotely monitoring patient variables, comprising:
attaching at least one patient-worn sensor to a patient;
providing a patient-worn monitoring unit connected to the sensor, wherein said patient-worn monitoring unit includes a processor and a wireless communication device connected to a first wireless network;
said patient-worn monitoring unit sending and receiving communications over the Internet via said first wireless network;
providing a Host data archive connected to the Internet to communicate with the patient-worn monitoring unit;
connecting a second network to the Internet and said first wireless network;
connecting a terminal to the second network for communication in a bi-directional manner between a medical care provider and the patient-worn monitoring unit over said second and first networks.

13. The method for remotely monitoring patient variables of claim 12, wherein the communication with the patient-worn monitoring unit is bi-directional data communication.

14. The method for remotely monitoring patient variables of claim 12, wherein the communication with the patient-worn monitoring unit is bi-directional voice communication.

15. The method for remotely monitoring patient variables of claim 13, wherein the bi-directional data communication sends instructions from the health care provider terminal to change configurable program instructions in the monitoring unit processor.

16. The method for remotely monitoring patient variables of claim 15, wherein the instructions sent to change configurable program instructions change alarm limits.

17. The method for remotely monitoring patient variables of claim 15, wherein the instructions sent to change configurable program instructions change data collection parameters for the at least one sensor.

18. The method for remotely monitoring patient variables of claim 14, wherein the bi-directional voice communications send and receive voice communications with a health care provider professional.

19. The method for remotely monitoring patient variables of claim 18, further comprising providing a microphone for allowing voice communications.

20. The method for remotely monitoring patient variables of claim 19, further comprising using the microphone and a speaker contained in the patient-worn monitoring unit to provide bi-directional voice communications.

21. The method for remotely monitoring patient variables of claim 12, wherein the second network is a PSTN.

22. The method for remotely monitoring patient variables of claim 12, wherein the sensor is a bio-sensor.
